(19) United States
(12) Patent Application Publication
(10) Pub. No.: US 2015/0266351 A1
(43) Pub. Date: Sep. 24, 2015

(54) Mount for Wheel Suspensions of a Motor Vehicle

(71) Applicant: ZF Friedrichshafen AG, Friedrichshafen (DE)

(72) Inventor: Robert SCHOENHERR, Oak Park, MI (US)

(21) Appl. No.: 14/296,867

(22) Filed: Jun. 5, 2014

(30) Foreign Application Priority Data
Mar. 20, 2014 (DE) 10 2014 205 194.0

(51) Int. Cl. B60G 11/24; B60G 11/22

(52) U.S. Cl. CPC B60G 11/24; B60G 11/22; B60G 2202/143; B60G 2204/125; B60G 2206/70

(57) ABSTRACT

A mount for wheel suspensions in a motor vehicle is provided with a housing and a buffer element from elastic or resilient material, in particular rubber, arranged in the housing, wherein the housing comprises an upper portion connectable to the body of a vehicle, and a lower portion, wherein the buffer element is arranged between the upper portion and the lower portion, and the lower portion is attached to the upper portion through form fit or interference fit or snap fit.

### BACKGROUND OF THE INVENTION

(1) Field of the Invention

The invention relates to a mount for wheel suspensions in a motor vehicle, comprising a housing and a buffer element from elastic material, in particular rubber.

(2) Description of Related Art

Such mount is known for example from DE 103 02 413 A1 and consists of a metallic housing having cup-shaped cross section, a rubber buffer arranged in the housing, and a support element that is fixed within the rubber buffer and can be connected to a piston/cylinder assembly. A similar mount is known from DE 10 2009 059 168 A1.

In the mount described in DE 103 02 413 A1, the rubber buffer is arranged between the cup-shaped housing and the body of a vehicle, i.e. the rubber buffer is directly supported by the body. Such mount can have an insufficient stiffness. Other types of mounts such as known from DE 10 2009 059 168 A1 have a complicated design.

### BRIEF SUMMARY OF THE INVENTION

Starting herefrom, it is an object to provide a mount for wheel suspensions in a motor vehicle that is sufficiently stiff, has a low weight and/or is easy to assemble.

This object is solved by the invention recited in claim 1. Advantageous embodiments are recited in the sub-claims.

According to the invention there is provided a mount for wheel suspensions in a motor vehicle, comprising a housing and a buffer element from elastic or resilient material, in particular rubber, arranged in the housing, wherein the housing comprises an upper portion connectable to the body of a vehicle, and a lower portion, wherein the buffer element is arranged between the upper portion and the lower portion, and the lower portion is attached to the upper portion through form fit or interference fit or snap fit.

Accordingly, the present invention is based on the realization that the rubber buffer can be provided in a stiff housing consisting of an upper portion and a lower portion, wherein the housing can be easily assembled by sticking or pushing together he upper and lower portions.

In an advantageous embodiment the lower portion consists of a plastics material, in particular fiber-reinforced plastics material (e.g. PA66 GF35). By employing a plastics material, the weight can be reduced. Also, at least one of the two portions of the housing thus has the elasticity or resilience that is advantageous for producing an interference fit.

The upper portion can be formed of a metal, in particular steel or aluminum. Thereby, the portion designated for attachment to the vehicle body has a high stiffness.

In one embodiment, the upper portion and the lower portion engage or adjoin one another at least partially in an axial direction. In this embodiment, a form-fit connection between the upper portion and the lower portion can be produced simply by sticking them together.

In one embodiment, in the area where the upper portion and the lower portion engage or adjoin one another, the upper portion and the lower portion have uneven surfaces that correspond to one another. This improves the form-fit between the upper portion and the lower portion.

In particular, in the area where the upper portion and the lower portion engage or adjoin one another, the upper portion and/or the lower portion can have at least one radial projection that engages a corresponding radial recess in the lower portion and/or upper portion, respectively. Thereby the form-fit is further improved.

In one embodiment the mount comprises an inner element having a cup-shaped cross-section that is connectable with a piston/cylinder assembly of a wheel suspension, wherein the buffer element is arranged between the inner element and the lower portion. In particular, the inner element is formed of a metal, for example steel or aluminum. In this embodiment the piston of a piston/cylinder assembly can be mounted to the inner element, instead of directly attaching it to the rubber buffer. Thereby a stable connection is achieved and the strain on the rubber buffer is reduced.

In a further embodiment, a substantially cylinder-shaped outer element is arranged between the buffer element and the lower portion. The outer element may be formed of a plastics material (e.g. PA66). Such additional outer element further increases the stiffness of the mount.

In one embodiment the upper portion comprises a flange for attaching, in particular by screw connection, the mount to the body of a vehicle. The upper portion and the flange can be formed integrally.

In the following, an embodiment of the invention is described by reference to the accompanying drawings. In the drawings:

### BRIEF DESCRIPTION OF THE SEVERAL VIEWS OF THE DRAWING(S)

FIG. 1 illustrates a top view of a mount according to an embodiment of the present invention;

FIG. 2 a cross-section through the mount along line A-A in Fig.

FIG. 3 the disassembled parts of a mount according to an embodiment of the invention;

FIG. 4 a cross-section through a mount according an embodiment of the invention in the mounted state: and

FIG. 5 a perspective view of the mount of FIG. 4.

### DETAILED DESCRIPTION OF THE INVENTION

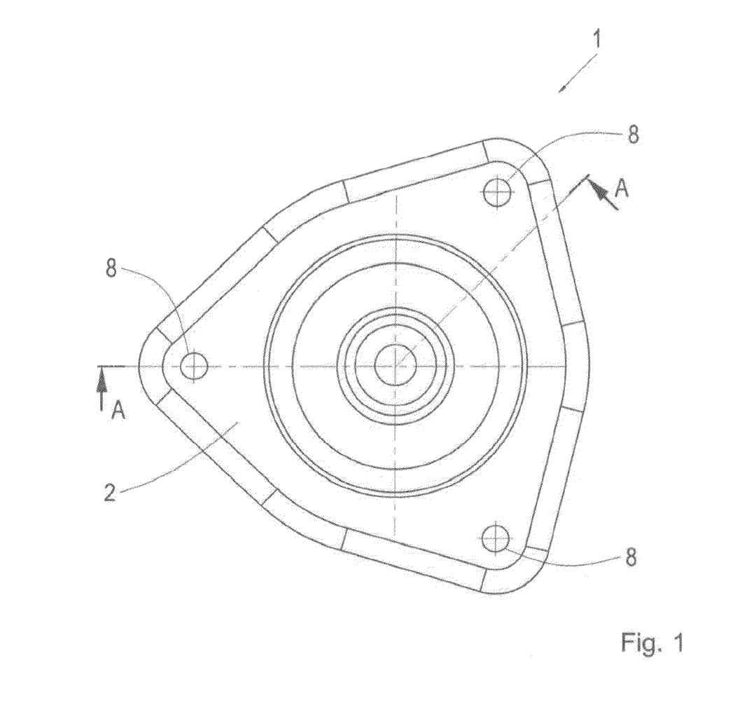

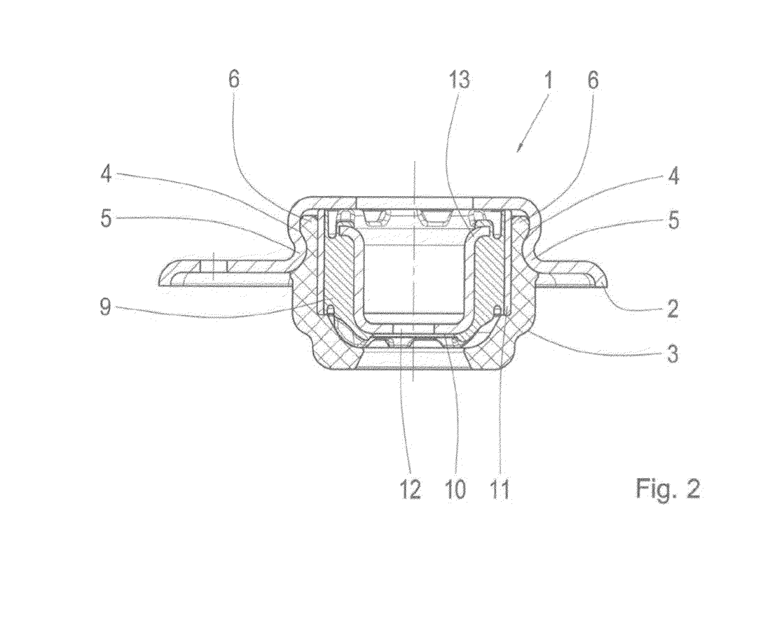

FIGS. 1 and 2 show a mount 1 according to an embodiment of the present invention. Figure illustrates the mount 1 in a cross-section along line A-A in FIG. 1. The mount 1 comprises an upper portion 2 of steel and a lower portion 2 connected thereto of a plastics material.

The upper portion 2 and the lower portion 3 have a substantially cup-shaped cross-section, wherein the cup openings face one another and the rims partially adjoin and engage one another. In this area 4, the rim 5 of the upper portion 2 as well as the rim 6 of the lower portion 3 have uneven surfaces, wherein the uneven surfaces correspond with and face one another. Thereby, the form-fit between the upper portion 2 and the lower portion 3 is improved. In particular, the surfaces adjoining one another have a substantially S-shaped cross-section, whereby radial projections are formed that engage with corresponding recesses at the counterpart.

During assembly, the rim 5 of the upper portion 2 is pushed over the rim 6 of the lower portion 3, wherein the rim 5 and/or the rim 6 are sufficiently resilient or elastic to enable an interference or snap fit between the upper portion 2 and the lower portion 3.

The upper portion 2 comprises a flange 6 with boreholes 8 through which the upper portion 2 can be screwed to a body of a vehicle that is not shown in FIGS. 1 and 2.

The assembled upper and lower portions 2 and 3 form an inner space in which a buffer element 9 of rubber is provided. In particular, the buffer element 9 is arranged in the space formed between the bottoms of the cup-shaped upper and lower portions 2 and 3. The buffer element 9 is substantially cylinder-shaped.

In a radial direction, the buffer element 9 is arranged between an inner element 10 and an outer element 11. The inner element 10 consists of steel and is provided for attaching a piston/cylinder assembly of a wheel suspension of a vehicle to the mount 1. The inner element 10 too has a substantially cup-shaped cross-section, wherein a borehole 12 is provided in the bottom through which a piston rod can extend inside the mount and attached to the inner element 10. The rim 13 of the inner element 10 is widened radially. The outer element consists of a plastics material and is cylinder-shaped.

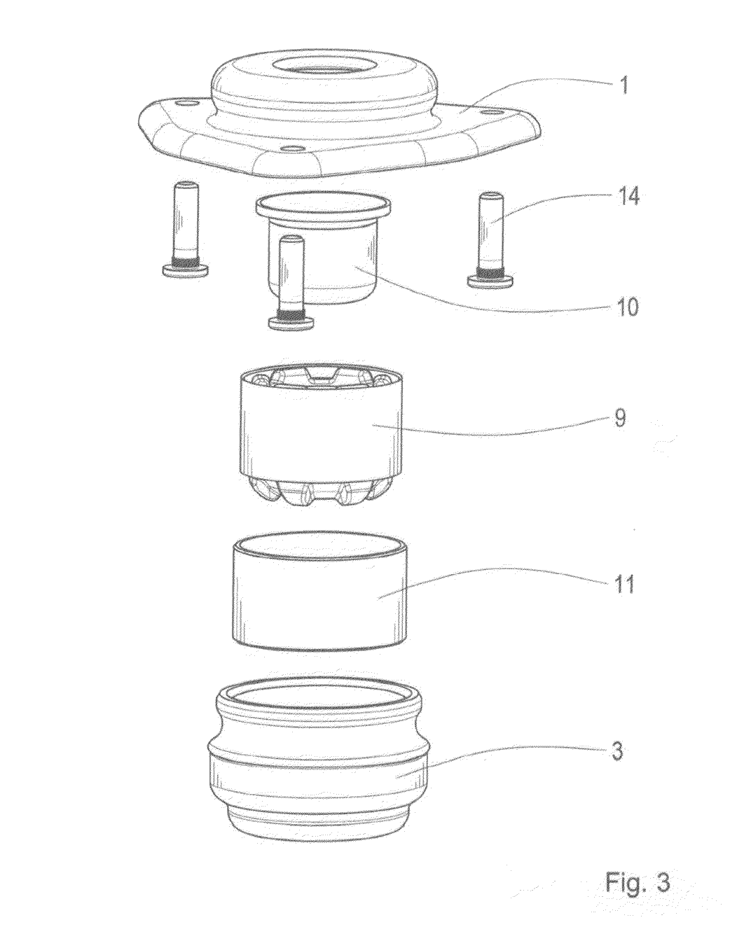

FIG. 3 illustrates the disassembled mount 1, wherein crews 14 for screwing the mount 1 to a body of a vehicle are additionally shown.

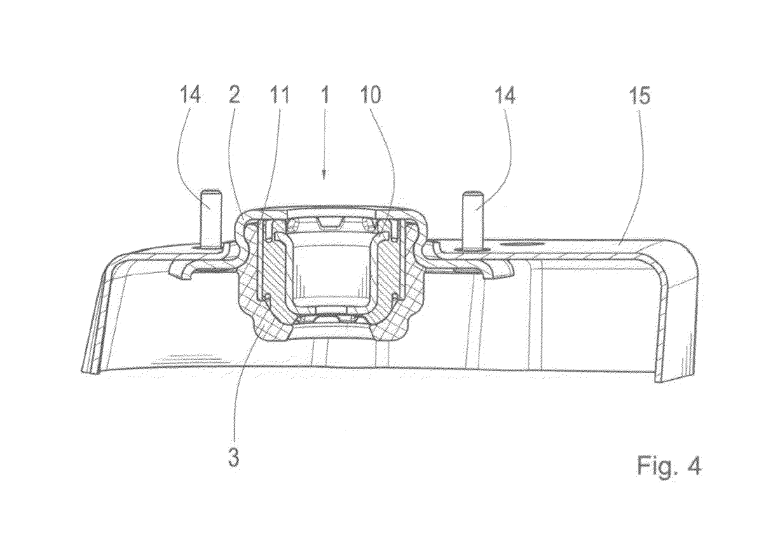

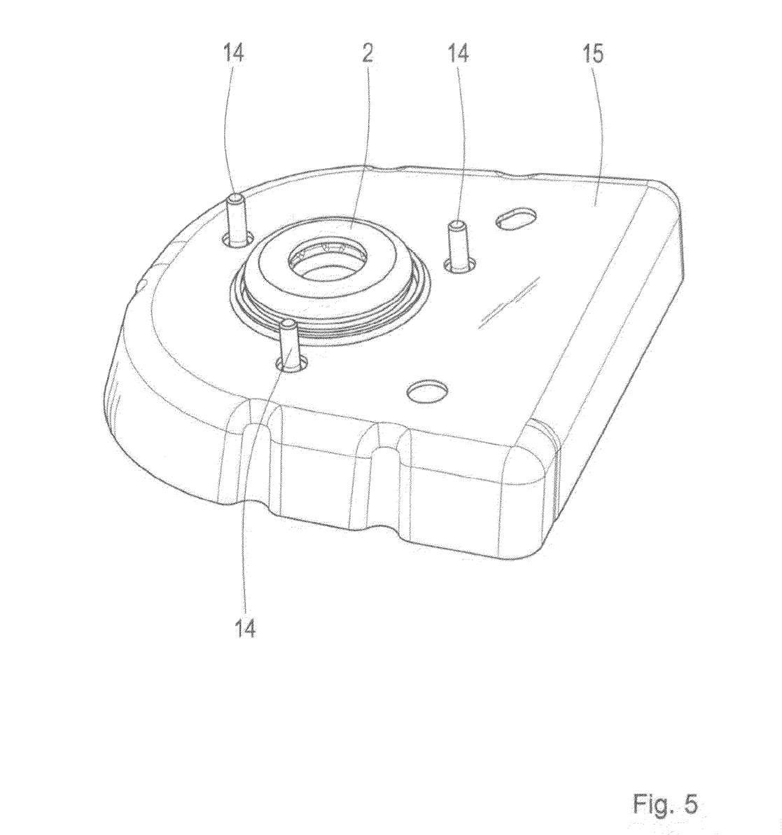

FIGS. 4 and 5 illustrate the mount 1 in its mounted state at a body part 15.

### REFERENCE NUMERALS

1 Mount
2 Upper portion
3 Lower portion
4 Area in which the upper portion and the lower portion engage one another
5 Rim of the upper portion
6 Rim of the lower portion
7 Flange
8 Boreholes
9 Buffer element
10 Inner element
11 Outer element
12 Borehole
13 Rim of the inner element
14 Screws
15 Body part

1. A mount (1) for wheel suspensions in a motor vehicle, comprising
a housing (2, 3) and
a buffer element (9) from elastic or resilient material arranged in the housing,
wherein the housing comprises an upper portion (2) connectable to the body of a vehicle, and a lower portion (3),
wherein the buffer element (9) is arranged between the upper portion (2) and the lower portion (3), and the lower portion (3) is attached to the upper portion (2) through form fit or interference fit or snap fit.

2. The mount (1) of claim 1, wherein the lower portion (3) is formed of plastics material.

3. The mount (1) of claim 1, wherein the upper portion (2) and the lower portion (3) engage or adjoin one another at least partially in an axial direction.

4. The mount (1) of claim 3, wherein in the area where the upper portion (2) and the lower portion (3) engage or adjoin one another, the upper portion (2) and the lower portion (3) have uneven surfaces that correspond to one another.

5. The mount (1) of claim 4, wherein in the area where the upper portion (2) and the lower portion (3) engage or adjoin one another, the upper portion (2) and/or the lower portion (3) has at least one radial projection that engages a corresponding radial recess in the lower portion (2) and/or upper portion (3), respectively.

6. The mount (1) of claim 1, wherein the upper portion (2) is formed of a metal, in particular steel or aluminum.

7. The mount (1) of claim 1, wherein the mount comprises an inner element (10) having a cup-shaped cross-section that is connectable with a piston/cylinder assembly of a wheel suspension, wherein the buffer element (9) is arranged between the inner element (10) and the lower portion (3).

8. The mount (1) of claim 7, wherein the inner element (10) is formed of a eta.

9. The mount (1) of claim 1, wherein a substantially cylinder-shaped outer element (11) is arranged between the buffer element (9) and the lower portion (3).

10. The mount (1) of claim 9, wherein the outer element (11) is formed of a plastics material.

11. The mount (1) of claim 1, wherein the upper portion (2) comprises a flange (7) for attaching the mount (1) to the body of a vehicle.

12. The mount (1) of claim 1, wherein the buffer element is made from rubber.

13. The mount (1) of claim 2, wherein the plastic material of the lower portion (3) is fiber-reinforced plastics material.

14. The mount (1) of claim 8, wherein the metal of the inner element (10) is steel or aluminum.

15. The mount (1) of claim 11, wherein the attaching of the flange is by screw connection.
